(19) United States
(12) Patent Application Publication
(10) Pub. No.: US 2025/0096583 A1
(43) Pub. Date: Mar. 20, 2025

(54) ELECTRONIC DEVICE AND BATTERY CONTROL METHOD

(71) Applicant: Samsung Electronics Co., Ltd., Suwon-si (KR)

(72) Inventor: Hyungwook CHOI, Suwon-si (KR)

(21) Appl. No.: 18/965,639

(22) Filed: Dec. 2, 2024

Related U.S. Application Data
(63) Continuation of application No. PCT/KR2023/007649, filed on Jun. 2, 2023.

(30) Foreign Application Priority Data
Jun. 3, 2022 (KR) 10-2022-0067993

(51) Int. Cl. H02J 7/00; H01M 10/44; H01M 10/46

(52) U.S. Cl. CPC H02J 7/00302; H01M 10/44; H01M 10/46; H02J 7/0013; H02J 7/007182; H02J 7/00306

(57) ABSTRACT

This electronic device may comprise: a first battery cell and a second battery cell connected in series to the first battery cell; a charging circuit configured to supply power of a first specified voltage from the outside to the first battery cell and the second battery cell; and at least one processor, comprising processing circuitry, individually and/or collectively, configured to control an overcharging protection operation voltage of the first battery cell and the second battery cell to a second specified voltage, wherein at least one processor, individually and/or collectively, is configured to; identify the voltage of the first battery cell and the voltage of the second battery cell while the first battery cell and the second battery cell are charged using the power of the first specified voltage; accumulate the number of times of overcharging protection operation for a battery cell having a voltage higher than the second specified voltage, based on at least one voltage among the voltage of the first battery cell and the voltage of the second battery cell being greater than the second specified voltage; and set an overcharging protection operation voltage for a battery cell having a voltage greater than the second specified voltage as a third specified voltage less than the second specified voltage, based on the number of times of the overcharging protection operation for the battery cell having a voltage greater than the second specified voltage reaches a specified number of times.

### CROSS-REFERENCE TO RELATED APPLICATIONS

This application is a continuation of International Application No. PCT/KR2023/007649 designating the United States, filed on Jun. 2, 2023, in the Korean Intellectual Property Receiving Office and claiming priority to Korean Patent Application No. 10-2022-0067993, filed on Jun. 3, 2022, in the Korean Intellectual Property Office, the disclosures of each of which are incorporated by reference herein in their entireties.

### BACKGROUND

### Field

The disclosure relates to an electronic device and a battery control method.

### Description of Related Art

Various mobile electronic devices such as mobile phones (including smartphones or mobile phones), tablet personal computers (PCs), and Note PCs are increasing. Electricity should be supplied to the mobile electronic devices for their operation, and the mobile electronic devices may include rechargeable batteries to secure mobility. Batteries included in electronic devices may have a battery pack form including multiple cells in which two or more battery cells are configured in series to operate the electronic devices for a long time without any external electricity supply.

A battery cell has a problem in that it cannot operate uniformly according to a manufacturing characteristic or a usage environment.

Due to difference in the performance or operation between battery cells of a battery included in an electronic device, overcharging may occur when the battery is charged.

### SUMMARY

Embodiments of the disclosure may provide an electronic device and a battery control method that may control an overcharge protection voltage when an overcharge protection operation is generated by a predetermined number of times or more when the battery is charged.

An electronic device according to an example embodiment of the disclosure includes: a first battery cell and a second battery cell connected to the first battery cell in series, a charging circuit configured to supply power of a first specified voltage from outside to the first battery cell and the second battery cell, and at least one processor, comprising processing circuitry, individually and/or collectively, configured to: control overcharge protection operation voltages of the first battery cell and the second battery cell to be a second specified voltage, identify a voltage of the first battery cell and a voltage of the second battery cell while the first battery cell and the second battery cell are charged using the power of the first specified voltage, based on at least one voltage of the voltage of the first battery cell and the voltage of the second battery cell being greater than the second specified voltage, accumulate a number of overcharge protection operations for a battery cell having a voltage greater than the second specified voltage, and based on the number of overcharge protection operations for the battery cell having the voltage greater than the second specified voltage reaching a specified number, configure an overcharge protection operation voltage for the battery cell having the voltage greater than the second specified voltage as a third specified voltage lower than the second specified voltage.

According to an example embodiment, a method of controlling a battery of an electronic device including a first battery cell and a second battery connected to the first battery cell in series may include: identifying a voltage of the first battery cell and a voltage of the second battery cell while the first battery cell and the second battery cell are charged using the power of the first specified voltage, based on at least one voltage of the voltage of the first battery cell and the voltage of the second battery cell being greater than the second specified voltage, accumulating a number of overcharge protection operations for a battery cell having a voltage greater than the second specified voltage, and based on the number of overcharge protection operations for the battery cell having the voltage greater than the second specified voltage reaches a specified number, configuring an overcharge protection operation voltage for the battery cell having the voltage greater than the second specified voltage as a third specified voltage lower than the second specified voltage.

A battery device according to an example embodiment the disclosure includes: a first battery cell and a second battery cell connected to the first battery cell in series, a charging circuit configured to supply power of a first specified voltage from outside to the first battery cell and the second battery cell, and at least one processor, comprising processing circuitry, individually and/or collectively, configured to: control overcharge protection operation voltages of the first battery cell and the second battery cell to be a second specified voltage, identify a voltage of the first battery cell and a voltage of the second battery cell while the first battery cell and the second battery cell are charged using the power of the first specified voltage, based on at least one voltage of the voltage of the first battery cell and the voltage of the second battery cell being greater than the second specified voltage, accumulate a number of overcharge protection operations for a battery cell having a voltage greater than the second specified voltage, and based on the number of overcharge protection operations for the battery cell having the voltage greater than the second specified voltage reaching a specified number, configure an overcharge protection operation voltage for the battery cell having the voltage greater than the second specified voltage as a third specified voltage lower than the second specified voltage.

The electronic device and the battery control method according to various embodiments of the disclosure may prevent and/or reduce deterioration of the performance of the battery by controlling the overcharge protection voltage.

### BRIEF DESCRIPTION OF THE DRAWINGS

With regard to the description of the drawings, the same or like reference signs may be used to designate the same or like elements. Further, the above and other aspects, features and advantages of certain embodiments of the present disclosure will be more apparent from the following detailed description, taken in conjunction with the accompanying drawings, in which:

FIG. 1 is a block diagram illustrating an example electronic device within a network environment according to various embodiments;

FIG. 2 is a diagram illustrating an electronic device according to various embodiments;

FIG. 3 is a block diagram illustrating an example configuration of the electronic device according to various embodiments;

FIG. 4 is a flowchart illustrating an example battery control method by the electronic device according to various embodiments;

FIG. 5 is a flowchart illustrating an example battery control method by the electronic device according to various embodiments;

FIG. 6 is a flowchart illustrating an example battery control method by the electronic device according to various embodiments;

FIG. 7 is a charging voltage graph of a normal electronic device including a battery cell;

FIG. 8 is a charging voltage graph of an electronic device including a battery cell according to various embodiments; and

FIG. 9 is a graph illustrating the number (cycle) of recharging of a battery cell according to a battery control operation according to various embodiments.

### DETAILED DESCRIPTION

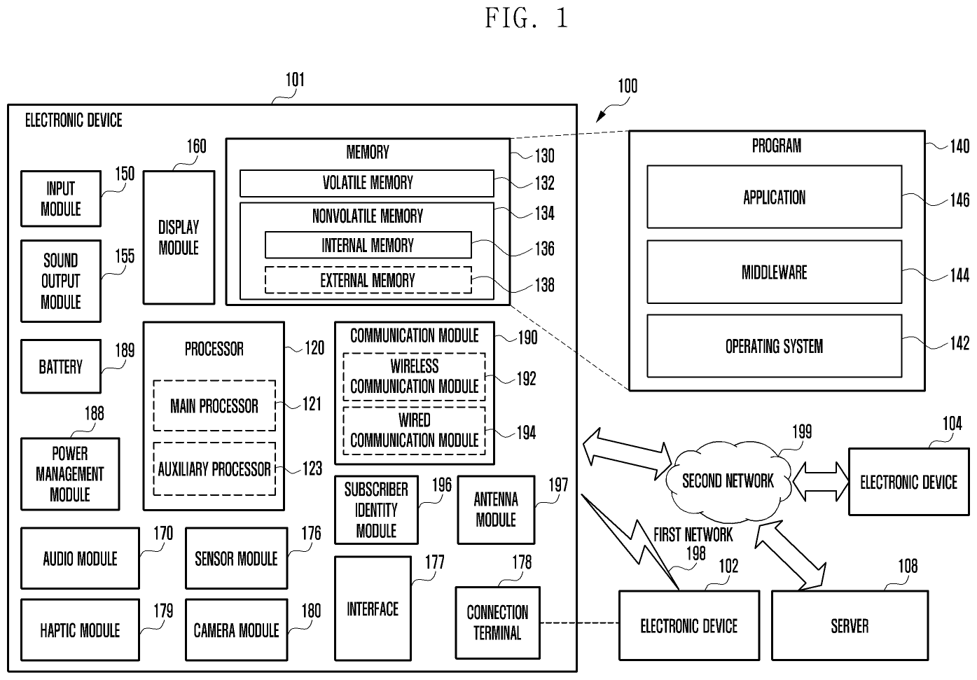

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (cMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

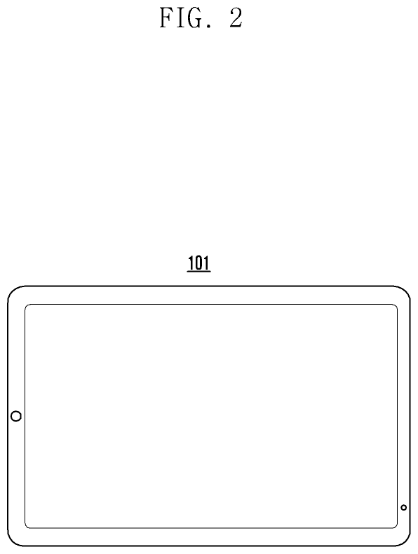

FIG. 2 is a diagram illustrating an example electronic device 101 according to various embodiments.

The electronic device 101 may include, for example, a Note personal computer (PC), a tablet PC, a portable communication device (for example, a smartphone), a computer device, a portable multimedia device, a portable medical device, a camera, a wearable device, or a home appliance. The electronic device 101 according to an embodiment of the disclosure is not limited to the above-described devices.

The electronic device 101 may include a battery pack or a battery device including a plurality of battery cells.

For the operation, electricity should be supplied to the portable electronic device 101, and the portable electronic device may include a rechargeable battery pack or battery device to secure mobility. The battery pack or battery device included in the electronic device 101 may have the form in which a plurality of battery cells is electrically connected to operate the electronic device for a long time without any external electricity supply. For example, the plurality of battery cells may be connected in series.

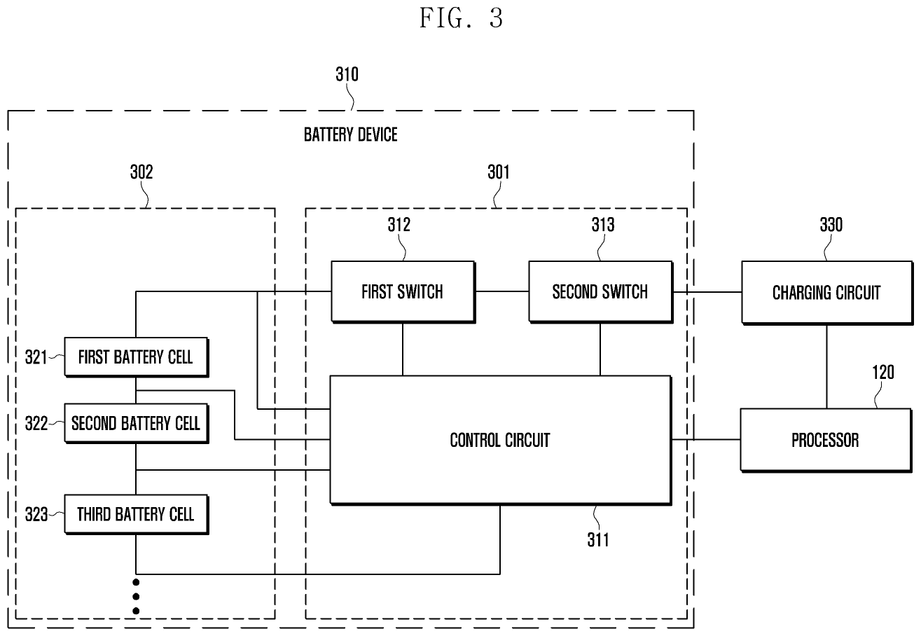

FIG. 3 is a block diagram illustrating an example configuration of the electronic device 101 according to various embodiments.

In an embodiment, the electronic device 101 may include the processor (e.g., including processing circuitry) 120, a battery device 310, and a charging circuit 330.

In an embodiment, the battery device 310 may include a battery control circuit 301 and a battery module 302. For example, the battery device 310 may be a battery pack. The battery control circuit 301 may control a charging operation of the battery module 302.

In an embodiment, the battery control circuit 301 may include a control circuit 311, a first switch 312, and/or a second switch 313. The battery control circuit 301 may be electrically connected to the battery module 302, the charging circuit 330, and/or the processor 120.

In an embodiment, the battery module 302 may include a plurality of battery cells 321, 322, and 323. The battery module 302 may be electrically connected to the battery control circuit 301.

In various embodiments, the battery module 302 may include a plurality of battery cells, and further include other battery cells as well as the first battery 321, the second battery 322, and/or the third battery 323 illustrated in FIG. 3.

In various embodiments, the battery module 302 may include a plurality of battery cells, for example, two or more battery cells (for example, the first battery cell 321 and the second battery cell 322).

In an embodiment, respective battery cells 321, 322, and 323 included in the battery module 302 may be connected to each other in series.

In an embodiment, the battery control circuit 301 may detect voltages of the battery cells 321, 322, and 323 included in the battery module 302. The battery control circuit 301 may control a charging and discharging operation of the battery cells 321, 322, and 323 connected in series. The battery control circuit 301 may be electrically connected to the battery module 302, the charging circuit 330, and/or the processor 120.

In various embodiments, the battery control circuit 301 may detect voltages of the battery cells 321, 322, and 323 included in the battery module 302 according to the control of the processor 120. The battery control circuit 301 may control the charging and discharging operation of the battery cells 321, 322, and 323 connected in series according to the control of the processor 120.

In an embodiment, each of the battery cells 321, 322, and 323 may have a uniform charging and discharging phenomenon according to a manufacturing characteristic and/or a user environment characteristic. For example, the battery cell may be a device that operates by a chemical reaction due to interval cathode/anode active materials. The battery cell has difference in a voltage band and capacity due to a difference in manufacturing characteristic caused by chemical input, activation stage after battery cell assembly, and temperature deviation. Further, the battery cell may have difference in a voltage band and capacity between battery cells due to the use of long-time charging and/or discharging or temperature difference between battery cells exposed to the outside.

In an embodiment, the battery control circuit 301 may control the charging operation of the battery module 302, based on a normal operation voltage range and/or a protection operation voltage range for each of the plurality of battery cells 321, 322, and 323.

In various embodiments, the battery control circuit 301 may control the charging operation of the battery module 302, based on the normal operation voltage range and/or the protection operation voltage range for each of the plurality of battery cells 321, 322, and 323 according to the control of the processor 120.

The protection operation voltage range may be a voltage range in which an overcharge protection operation voltage is the upper limit and an overdischarge protection operation voltage is the lower limit. The protection operation voltage range is a voltage range for preventing/reducing loss of the battery cell by overcharge and/or overdischarge, and when the battery cell has a voltage that exceeds the protection operation voltage range, the electronic device 101 and/or the battery device 310 may block the charging and/or discharging operation of the battery cell.

In an embodiment, the normal operation voltage range may be between a first voltage and a second voltage. The first voltage may be higher than the second voltage. For example, the first voltage may be 4.35 V, and the second voltage may be 3 V.

In an embodiment, the protection operation voltage range may be between a third voltage and a fourth voltage. The third voltage may be higher than the fourth voltage. The third voltage may be higher than the first voltage. The fourth voltage may be lower than the second voltage. For example, the third voltage may be 4.4 V, and the fourth voltage may be 2.5 V.

In an embodiment, when the voltage of each of the plurality of battery cells 321, 322, and 323 is detected in the normal operation voltage range, the battery control circuit 301 may maintain the charging or discharging operation for the entire battery module 302.

In various embodiments, when the voltage of each of the plurality of battery cells 321, 322, and 323 is detected in the normal operation voltage range, the battery control circuit 301 may maintain the charging or discharging operation for all of the plurality of battery cells 321, 322, and 323.

In an embodiment, when the voltage of each of the plurality of battery cells 321, 322, and 323 is detected in the protection operation voltage range, the battery control circuit 301 may block the charging or discharging operation for the entire battery module 302.

In various embodiments, when the voltage of each of the plurality of battery cells 321, 322, and 323 is detected in the protection operation voltage range, the battery control circuit 301 may block the charging or discharging operation for all of the plurality of battery cells 321, 322, and 323.

In an embodiment, the control circuit 311 may detect the voltage of each of the battery cells 321, 322, and 323 included in the battery module 302. The control circuit 311 may control the charging and discharging operation of the battery module 302. For example, the control circuit 311 may control the charging operation of the battery module 302 by controlling the first switch 312. The control circuit 311 may control the discharging operation of the battery module 302 by controlling the second switch 313.

In an embodiment, when it is detected that each of the plurality of battery cells 321, 322, and 323 has the voltage that exceeds the protection operation voltage range, the control circuit 311 may block the charging operation for the entire battery module 302 by controlling the first switch 312.

For example, in an embodiment, when it is detected that each of the plurality of battery cells 321, 322, and 323 has the voltage that exceeds the third voltage (for example, 4.4 V) corresponding to the protection operation voltage, the control circuit 311 may block the charging operation for the entire battery module 302 by controlling the first switch 312.

In various embodiments, when it is detected that each of the plurality of battery cells 321, 322, and 323 has the voltage that is lower than the protection operation voltage range, the control circuit 311 may block the discharging operation for the entire battery module 302 by controlling the second switch 313.

For example, when it is detected that each of the plurality of battery cells 321, 322, and 323 has the voltage that is lower than the fourth voltage (for example, 2.5 V) corresponding to the protection operation voltage range, the control circuit 311 may block the discharging operation for the entire battery module 302 by controlling the second switch 313.

In an embodiment, the processor 120 may be electrically connected to the battery control circuit 301 and/or the charging circuit 330. The description above with respect to processor 120 applies equally here.

In an embodiment, the processor 120 may detect the voltage of each of the battery cells 321, 322, and 323 included in the battery module 302 by controlling the control circuit 311 and/or the battery control circuit 301.

In an embodiment, the processor 120 may control the charging operation of the battery module 302, based on the normal operation voltage range and/or the protection operation voltage range for each of the plurality of battery cells 321, 322, and 323 by controlling the control circuit 311 and/or the battery control circuit 301.

In an embodiment, when the voltage of each of the battery cells 321, 322, and 323 is detected in the normal operation voltage range by controlling the control circuit 311 and/or the battery control circuit 301, the processor 120 may maintain the charging or discharging operation for the entire battery module 302.

In various embodiments, when the voltage of each of the battery cells 321, 322, and 323 is detected in the normal operation voltage range by controlling the control circuit 311 and/or the battery control circuit 301, the processor 120 may maintain the charging or discharging operation for all of the plurality of battery cells 321, 322, and 323.

In an embodiment, when the voltage of each of the battery cells 321, 322, and 323 is detected in the protection operation voltage range by controlling the control circuit 311 and/or the battery control circuit 301, the processor 120 may block the charging or discharging operation for the entire battery module 302.

In various embodiments, when the voltage of each of the battery cells 321, 322, and 323 is detected in the protection operation voltage range by controlling the control circuit 311 and/or the battery control circuit 301, the processor 120 may block the charging or discharging operation for all of the plurality of battery cells 321, 322, and 323.

In an embodiment, when it is detected that each of the plurality of battery cells 321, 322, and 323 has the voltage that exceeds the protection operation voltage range by controlling the control circuit 311 and/or the battery control circuit 301, the processor 120 may block the charging or discharging operation for the entire battery module 302 by controlling the first switch 312.

In various embodiments, when it is detected that each of the plurality of battery cells 321, 322, and 323 has the voltage that is lower than the protection operation voltage range by controlling the control circuit 311 and/or the battery control circuit 301, the processor 120 may block the charging or discharging operation for the entire battery module 302 by controlling the second switch 313.

In an embodiment, the charging circuit 330 may be electrically connected to the processor 120 and/or the battery control circuit 301.

In an embodiment, the charging circuit 330 may supply power to the battery device 310 according to the control of the processor 120. The battery device 310 may charge the battery cell included in the battery module 302, based on the power supplied from the charging circuit 330.

In an embodiment, the charging circuit 330 may supply power supplied from the outside to the battery device 310 according to the control of the processor 120.

In an embodiment, the charging circuit 330 may supply power output from the battery device 310 to the inside of the electronic device 101 according to the control of the processor 120.

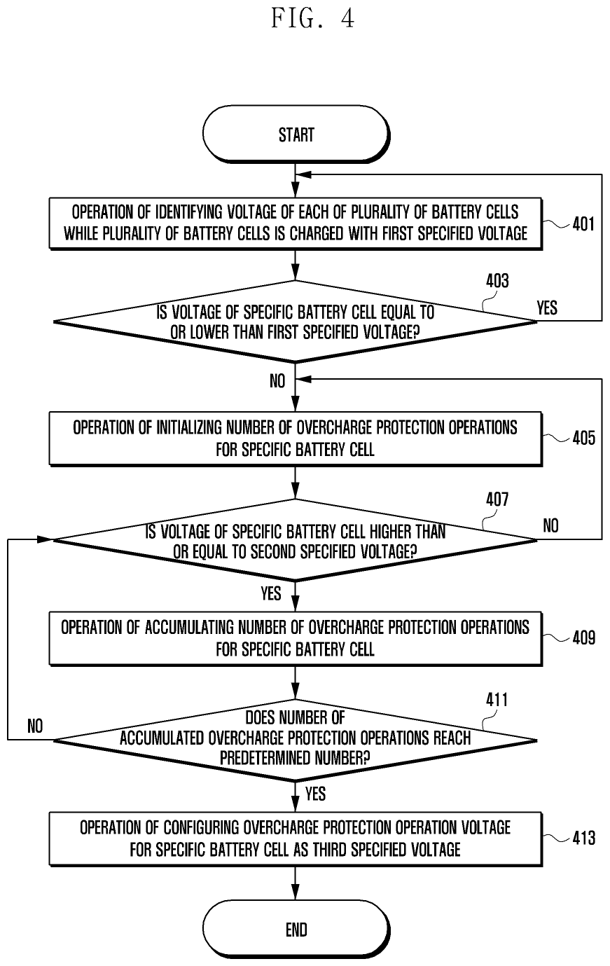

FIG. 4 is a flowchart illustrating an example battery control method by the electronic device 101 according to various embodiments.

In an embodiment, the electronic device 101 may identify the voltage of each of the plurality of battery cells 321, 322, and 323 while the plurality of battery cells 321, 322, and 323 included in the battery module 302 is charged with power of a first specified voltage according to the control of the processor 120 and/or the control circuit 311 in operation 401. In an embodiment, the first specified voltage may be a voltage corresponding to the normal operation voltage range. The first specified voltage may be, for example, 4.35 V. For example, the first specified voltage may be the upper limit voltage in the normal operation voltage range.

In an embodiment, the electronic device 101 may identify the voltage of the first battery cell 321, the second battery cell 322, and/or the third battery cell 323 while the first battery cell 321, the second battery cell 322, and/or the third battery cell 323 are charged with power of the first specified voltage according to the control of the processor 120 and/or the control circuit 311 in operation 401.

In an embodiment, the electronic device 101 may identify whether a voltage of a specific battery cell among the plurality of battery cells 321, 322, and 323 included in the battery module 302 is equal to or lower than the first specified voltage according to the control of the processor 120 and/or the control circuit 311 in operation 403.

When the voltage of the specific battery cell among the plurality of battery cells 321, 322, and 323 included in the battery module 302 is higher than the first specified voltage, the electronic device 101 may proceed to operation 405 from operation 403.

When the voltage of the specific battery cell among the plurality of battery cells 321, 322, and 323 included in the battery module 302 is lower than the first specified voltage, the electronic device 101 may proceed to operation 401 from operation 403.

In an embodiment, the electronic device 101 may initialize the number of overcharge protection operations for the specific battery cell that exceeds the first specified voltage according to the control of the processor 120 and/or the control circuit 311 in operation 405. For example, the operation of initializing the number of overcharge protection operations may be an operation of counting the number of overcharge protection operations as 0.

In various embodiments, the electronic device 101 may count the number of overcharge protection operations for the specific battery cell that exceeds the first specified voltage according to the control of the processor 120 and/or the control circuit 311 in operation 405. For example, in operation 405, the operation of initializing the number of overcharge protection operations may be an operation of configuring a count value as 0.

In an embodiment, the electronic device 101 may identify whether the voltage of the specific battery cell that exceeds the first specified voltage is higher than or equal to a second specified voltage according to the control of the processor 120 and/or the control circuit 311 in operation 407.

In an embodiment, the second specified voltage may be a voltage corresponding to the protection operation voltage range. The second specified voltage may be, for example, 4.4 V.

When the voltage of the specific battery cell that exceeds the first specified voltage is higher than or equal to the second specified voltage, the electronic device 101 may proceed to operation 409 from operation 407.

When voltage of the specific battery cell that exceeds the first specified voltage is lower than the second specified voltage, the electronic device 101 may proceed to operation 405 from operation 407.

In an embodiment, the electronic device 101 may accumulate the number of overcharge protection operations for the specific battery cell having the voltage higher than or equal to the second specified voltage according to the control of the processor 120 and/or the control circuit 311 in operation 409. For example, in operation 409, the operation of accumulating the number of overcharge protection operations may be an operation of increasing the count value by 1.

In an embodiment, the electronic device 101 may determine whether the number of accumulated overcharge protection operations reaches a predetermined number according to the control of the processor 120 and/or the control circuit 311 in operation 411. In operation 411, the operation in which the electronic device 101 determines whether the number of accumulated overcharge protection operations reaches a predetermined number according to the control of the processor 120 and/or the control circuit 311 may be determined according to whether the count value corresponding to the number of accumulated overcharge protection operations reaches a predetermined count value.

For example, the predetermined number may be 3. The predetermined number may be larger than or equal to or equal to or smaller than 3, and may be changed by software stored in the electronic device 101.

In various embodiments, the electronic device 101 may determine whether the number of accumulated overcharge protection operations is successively accumulated and reaches the predetermined number according to the control of the processor 120 and/or the control circuit 311 in operation 411.

When the number of accumulated overcharge protection operations reaches the predetermined number, the electronic device 101 may proceed to operation 413 from operation 411.

When the number of accumulated overcharge protection operations does not reach the predetermined number, the electronic device 101 may proceed to operation 407 from operation 411.

In an embodiment, the electronic device 101 may configure, as a third specified voltage, the overcharge protection operation voltage for the specific battery cell having the number of accumulated overcharge protection operations that reaches the predetermined number according to the control of the processor 120 and/or the control circuit 311 in operation 413.

In various embodiments, when the number of accumulated overcharge protection operations is successively accumulated and reaches the predetermined number according to the control of the processor 120 and/or the control circuit 311, the electronic device 101 may configure the overcharge protection operation voltage for the specific battery cell as the third specified voltage in operation 413.

The protection operation voltage range may be a voltage range in which an overcharge protection operation voltage is the upper limit and an overdischarge protection operation voltage is the lower limit. The protection operation voltage range is a voltage range for preventing/reducing loss of the battery cell by overcharge and/or overdischarge, and when the battery cell has a voltage that exceeds the protection operation voltage range, the electronic device 101 and/or the battery device 310 may block the charging and/or discharging operation of the battery cell.

In an embodiment, the second specified voltage and the third specified voltage may be overcharge protection operation voltages. The third specified voltage may be lower than the second specified voltage. For example, the second specified voltage may be 4.4 V, and the third specified voltage may be 4.35 V.

In various embodiments, the electronic device 101 may configure the overcharge protection operation voltage for the specific battery cell having the number of accumulated overcharge protection operations that reaches the predetermined number to be reduced to a predetermined voltage according to the control of the processor 120 and/or the control circuit 311 in operation 413. The second specified voltage may be the overcharge protection operation voltage. For example, in operation 413, the electronic device 101 may configure the overcharge protection operation voltage as 4.35 V by lowering the second specified voltage of 4.4 V by 0.05 V.

In various embodiments, the battery device 310 may identify the voltage of each of the plurality of battery cells 321, 322, and 323 while the plurality of battery cells 321, 322, and 323 included in the battery module 302 is charged with power of the first specified voltage according to the control of the control circuit 311 in operation 401.

In various embodiments, the battery device 310 may identify whether the voltage of a specific battery cell among the plurality of battery cells 321, 322, and 323 included in the battery module 302 is equal to or lower than the first specified voltage according to the control of the control circuit 311 in operation 403.

When the voltage of the specific battery cell among the plurality of battery cells 321, 322, and 323 included in the battery module 302 exceeds the first specified voltage, the battery device 310 may proceed to operation 405 from operation 403.

When the voltage of the specific battery cell among the plurality of battery cells 321, 322, and 323 included in the battery module 302 is lower than the first specified voltage, the battery device 310 may proceed to operation 401 from operation 403.

In various embodiments, the battery device 310 may initialize the number of overcharge protection operations for the specific battery cell that exceeds the first specified voltage according to the control of the control circuit 311 in operation 405. For example, the operation of initializing the number of overcharge protection operations may be an operation of counting the number of overcharge protection operations as 0.

In various embodiments, the battery device 310 may count the number of overcharge protection operations for the specific battery cell that exceeds the first specified voltage according to the control of the control circuit 311 in operation 405. For example, in operation 405, the operation of initializing the number of overcharge protection operations may be an operation of configuring a count value as 0. In various embodiments, the battery device 310 may identify whether the voltage of the specific battery cell that exceeds the first specified voltage is higher than or equal to the second specified voltage according to the control of the control circuit 311 in operation 407.

When the voltage of the specific battery cell that exceeds the first specified voltage is higher than or equal to the second specified voltage, the battery device 310 may proceed to operation 409 from operation 407.

When the voltage of the specific battery cell that exceeds the first specified voltage is lower than the second specified voltage, the battery device 310 may proceed to operation 405 from operation 407.

In various embodiments, the battery device 310 may accumulate the number of overcharge protection operations for the specific battery cell having the voltage that is higher than or equal to the second specified voltage according to the control of the control circuit 311 in operation 409.

In various embodiments, the battery device 310 may determine whether the number of accumulated overcharge protection operations reaches a predetermined number according to the control of the control circuit 311 in operation 411.

When the number of accumulated overcharge protection operations reaches the predetermined number, the battery device 310 may proceed to operation 413 from operation 411.

When the number of accumulated overcharge protection operations does not reach the predetermined number, the battery device 310 may proceed to operation 407 from operation 411.

In various embodiments, the battery device 310 may configure, as the third specified voltage, the overcharge protection operation voltage for the specific battery cell having the number of accumulated overcharge protection operations that reaches the predetermined number according to the control of the control circuit 311 in operation 413.

In various embodiments, the battery device 310 may configure the overcharge protection operation voltage for the specific battery cell having the number of accumulated overcharge protection operations that reaches the predetermined number to be reduced by a predetermined voltage according to the control of the control circuit 311 in operation 413.

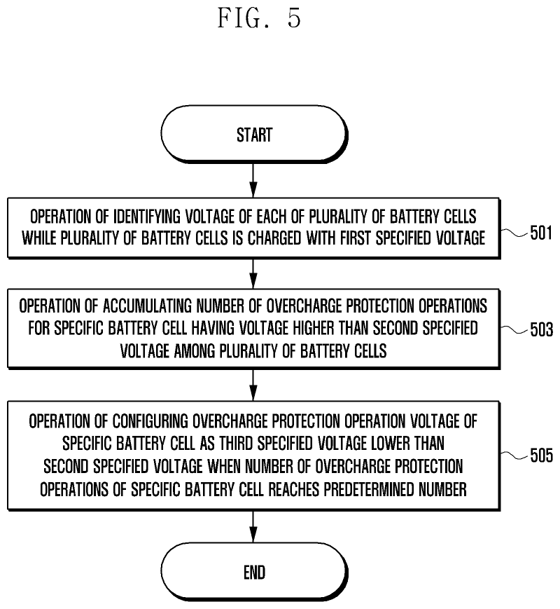

FIG. 5 is a flowchart illustrating an example battery control method by the electronic device 101 according to various embodiments.

In an embodiment, the electronic device 101 may identify the voltage of each of the plurality of battery cells 321, 322, and 323 while the plurality of battery cells 321, 322, and 323 included in the battery module 302 is charged with power of the first specified voltage according to the control of the processor 120 and/or the control circuit 311 in operation 501. In an embodiment, the first specified voltage may be a voltage corresponding to the normal operation voltage range. The first specified voltage may be, for example, 4.35 V. For example, the first specified voltage may be the upper limit voltage in the normal operation voltage range.

In an embodiment, the electronic device 101 may identify the voltage of the first battery cell 321, the second battery cell 322, and/or the third battery cell 323 while the first battery cell 321, the second battery cell 322, and/or the third battery cell 323 are charged with power of the first specified voltage according to the control of the processor 120 and/or the control circuit 311 in operation 501.

In an embodiment, the electronic device 101 may accumulate the number of overcharge protection operations for a specific battery cell having a voltage higher than the second specified voltage among the plurality of battery cells 321, 322, and 323 included in the battery module 302 according to the control of the processor 120 and/or the control circuit 311 in operation 503.

In an embodiment, the second specified voltage may be a voltage corresponding to the protection operation voltage range. The second specified voltage may be, for example, 4.4 V. For example, in operation 503, the operation of accumulating the number of overcharge protection operations may be an operation of adding the count value by 1.

In an embodiment, when the number of overcharge protection operations of the specific battery cell reaches a predetermined number according to the control of the processor 120 and/or the control circuit 311, the electronic device 101 may configure the overcharge protection operation voltage of the specific battery cell as the third specified voltage that is lower than the second specified voltage in operation 505.

In an embodiment, in operation 505, the operation in which the electronic device 101 determines whether the number of accumulated overcharge protection operations of the specific battery cell reaches the predetermined number according to the control of the processor 120 and/or the control circuit 311 may be determined according to whether a count value corresponding to the number of accumulated overcharge protection operations reaches a predetermined count value.

In an embodiment, the predetermined number may be 3. The predetermined number may be larger than or equal to or equal to or smaller than 3, and may be changed by software stored in the electronic device 101.

In various embodiments, the electronic device 101 may determine whether the number of accumulated overcharge protection operations is successively accumulated and reaches the predetermined number according to the control of the processor 120 and/or the control circuit 311 in operation 505.

In various embodiments, when the number of accumulated overcharge protection operations of the specific battery cell is successively accumulated and reaches the predetermined number according to the control of the processor 120 and/or the control circuit 311, the electronic device 101 may configure the overcharge protection operation voltage of the specific battery cell as the third specified voltage that is lower than the second specified voltage in operation 505.

In an embodiment, the second specified voltage and the third specified voltage may be overcharge protection operation voltages. The third specified voltage may be lower than the second specified voltage. For example, the second specified voltage may be 4.4 V, and the third specified voltage may be 4.35 V.

In various embodiments, when the number of overcharge protection operations of the specific battery cell reaches the predetermined number according to the control of the processor 120 and/or the control circuit 311, the electronic device 101 may configure the overcharge protection operation voltage of the specific battery cell to be reduced by a predetermined voltage in operation 505. The second specified voltage may be the overcharge protection operation voltage. For example, in operation 413, the electronic device 101 may configure the overcharge protection operation voltage as 4.35 V by lowering the second specified voltage of 4.4 V by 0.05 V.

In various embodiments, the battery device 310 may identify the voltage of each of the plurality of battery cells 321, 322, and 323 while the plurality of battery cells 321, 322, and 323 included in the battery module 302 is charged with power of the first specified voltage according to the control of the control circuit 311 in operation 501. In an embodiment, the first specified voltage may be a voltage corresponding to the normal operation voltage range. The first specified voltage may be, for example, 4.35 V.

In various embodiments, the battery device 310 may identify the voltage of the first battery cell 321, the second battery cell 322, and/or the third battery cell 323 while the first battery cell 321, the second battery cell 322, and/or the third battery cell 323 are charged with power of the first specified voltage according to the control of the control circuit 311 in operation 501.

In various embodiments, the battery device 310 may accumulate the number of overcharge protection operations for a specific battery cell having a voltage higher than the second specified voltage among the plurality of battery cells 321, 322, and 323 included in the battery module 302 according to the control of the control circuit 311 in operation 503.

In various embodiments, when the number of overcharge protection operations of the specific battery cell reaches a predetermined number according to the control of the control circuit 311, the battery device 310 may configure the overcharge protection operation voltage of the specific battery cell as the third specified voltage that is lower than the second specified voltage in operation 505.

In various embodiments, when the number of overcharge protection operations of the specific battery cell reaches the predetermined number according to the control of the control circuit 311, the battery device 310 may configure the overcharge protection operation voltage of the specific battery cell to be reduced by a predetermined voltage in operation 505. The second specified voltage may be the overcharge protection operation voltage. For example, in operation 413, the electronic device 101 may configure the overcharge protection operation voltage as 4.35 V by lowering the second specified voltage of 4.4 V by 0.05 V.

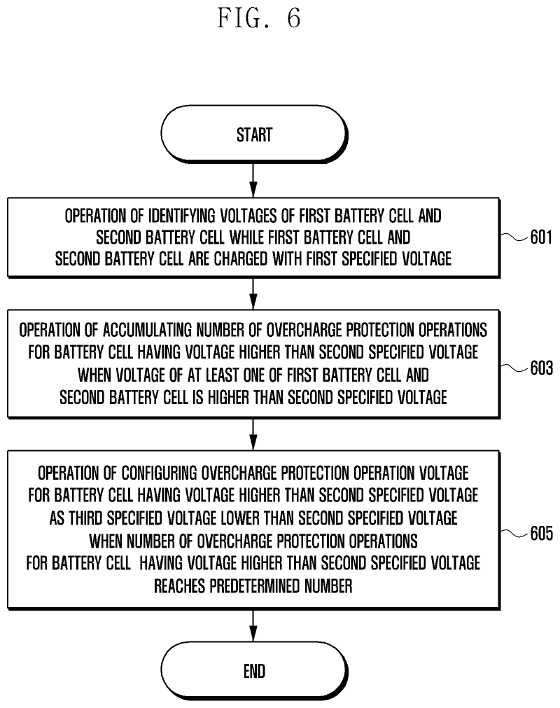

FIG. 6 is a flowchart illustrating an example battery control method by the electronic device 101 according to various embodiments.

In an embodiment, the electronic device 101 may identify the voltage of each of the first battery cell 321 and the second battery cell 322 while the first battery cell 321 and the second battery cell 322 included in the battery module 302 are charged with power of the first specified voltage according to the control of the processor 120 and/or the control circuit 311 in operation 601. In an embodiment, the first specified voltage may be a voltage corresponding to the normal operation voltage range. The first specified voltage may be, for example, 4.35 V. For example, the first specified voltage may be the upper limit voltage in the normal operation voltage range.

In an embodiment, when the voltage of at least one battery cell among the voltage of the first battery cell 321 and the voltage of the second battery cell 322 is higher than the second specified voltage according to the control of the processor 120 and/or the control circuit 311, the electronic device 101 may accumulate the number of overcharge protection operations for the battery cell having the voltage higher than the second specified voltage in operation 603.

In an embodiment, the second specified voltage may be a voltage corresponding to the protection operation voltage range. The second specified voltage may be, for example, 4.4 V. For example, in operation 603, the operation of accumulating the number of overcharge protection operations may be an operation of adding the count value by 1.

In an embodiment, when the number of overcharge protection operations for the battery cell having the voltage higher than the second specified voltage reaches a predetermined number according to the control of the processor 120 and/or the control circuit 311, the electronic device 101 may configure the overcharge protection operation voltage for the battery cell having the voltage higher than the second specified voltage as the third specified voltage that is lower than the second specified voltage in operation 605.

In an embodiment, in operation 605, the operation in which the electronic device 101 determines whether the number of overcharge protection operations for the battery cell having the voltage higher than the second specified voltage reaches the predetermined number according to the control of the processor 120 and/or the control circuit 311 may be determined according to whether a count value corresponding to the number of overcharge protection operations reaches a predetermined count value in operation 605.

In an embodiment, the predetermined number may be 3. The predetermined number may be larger than or equal to or equal to or smaller than 3, and may be changed by software stored in the electronic device 101.

In various embodiments, the electronic device 101 may determine whether the number of accumulated overcharge protection operations for the battery cell having the voltage higher than the second specified voltage is successively accumulated and reaches the predetermined number according to the control of the processor 120 and/or the control circuit 311 in operation 605.

In various embodiments, when the number of accumulated overcharge protection operations for the battery cell having the voltage higher than the second specified voltage is successively accumulated and reaches the predetermined number according to the control of the processor 120 and/or the control circuit 311, the electronic device 101 may configure the overcharge protection operation voltage for the battery cell having the voltage higher than the second specified voltage as the third specified voltage that is lower than the second specified voltage in operation 605.

In an embodiment, the protection operation voltage range may be a voltage range in which the overcharge protection operation voltage is the upper limit and the overdischarge protection operation voltage is the lower limit. The protection operation voltage range is a voltage range for preventing/reducing loss of the battery cell by overcharge and/or overdischarge, and when the battery cell has a voltage that exceeds the protection operation voltage range, the electronic device 101 and/or the battery device 310 may block the charging and/or discharging operation of the battery cell.

In an embodiment, the second specified voltage and the third specified voltage may be overcharge protection operation voltages. The third specified voltage may be lower than the second specified voltage. For example, the second specified voltage may be 4.4 V, and the third specified voltage may be 4.35 V.

In various embodiments, when number of overcharge protection operations for the battery cell having the voltage higher than the second specified voltage reaches the predetermined number according to the control of the processor 120 and/or the control circuit 311, the electronic device 101 may configure the overcharge protection operation voltage for the battery cell having the voltage higher than the second specified voltage to be reduced by a predetermined voltage in operation 605. The second specified voltage may be the overcharge protection operation voltage. For example, in operation 413, the electronic device 101 may configure the overcharge protection operation voltage as 4.35 V by lowering the second specified voltage of 4.4 V by 0.05 V.

In various embodiments, the battery device 310 may identify the voltage of each of the first battery cell 321 and the second battery cell 322 while the first battery cell 321 and the second battery cell 322 included in the battery module 302 are charged with power of the first specified voltage according to the control of the control circuit 311 in operation 601. In an embodiment, the first specified voltage may be a voltage corresponding to the normal operation voltage range. The first specified voltage may be, for example, 4.35 V.

In various embodiments, when the voltage of at least one battery cell among the voltage of the first battery cell 321 and the voltage of the second battery cell 322 is higher than the second specified voltage according to the control of the control circuit 311, the battery device 310 may accumulate the number of overcharge protection operations for the battery cell having the voltage higher than the second specified voltage in operation 603.

In an embodiment, the second specified voltage may be a voltage corresponding to the protection operation voltage range. The second specified voltage may be, for example, 4.4 V. For example, in operation 603, the operation of accumulating the number of overcharge protection operations may be an operation of adding the count value by 1.

In various embodiments, when the number of overcharge protection operations for the battery cell having the voltage higher than the second specified voltage reaches the predetermined number according to the control of the control circuit 311, the battery device 310 may configure the overcharge protection operation voltage for the battery cell having the voltage higher than the second specified voltage as the third specified voltage that is lower than the second specified voltage in operation 605.

In an embodiment, in operation 605, the operation in which the battery device 310 determines whether the number of overcharge protection operations for the battery cell having the voltage higher than the second specified voltage reaches the predetermined number according to the control of the control circuit 311 may be determined according to whether a count value corresponding to the number of accumulated overcharge protection operations reaches a predetermined count value.

In various embodiments, when the number of overcharge protection operations for the battery cell having the voltage higher than the second specified voltage reaches the predetermined number according to the control of the control circuit 311, the battery device 310 may configure the overcharge protection operation voltage for the battery cell having the voltage higher than the second specified voltage to be reduced by a predetermined voltage in operation 605. The second specified voltage may be the overcharge protection operation voltage. For example, in operation 413, the electronic device 101 may configure the overcharge protection operation voltage as 4.35 V by lowering the second specified voltage of 4.4 V by 0.05 V.

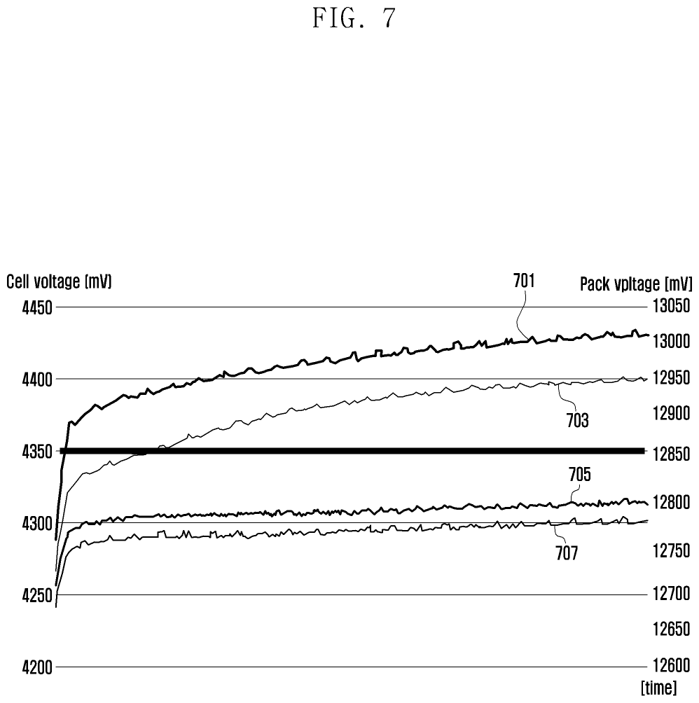

FIG. 7 is a charging voltage graph of a normal electronic device including a battery cell.

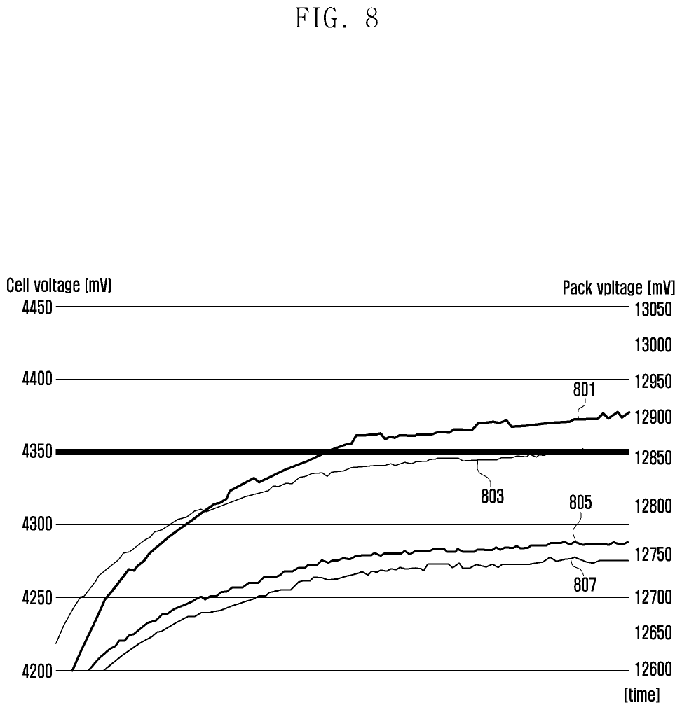

FIG. 8 is a charging voltage graph of an electronic device including a battery cell according to various embodiments.

In FIG. 7, a graph 701 is a graph showing a voltage applied to the battery module 302 or the battery pack. A graph 705 and a graph 707 are graphs showing charging voltages of the battery cell that operates within a normal operation voltage range of 4.35 V. A graph 703 is a graph showing a battery cell that continues a charging operation even in a voltage exceeding the normal operation voltage range of 4.35 V. The normal electronic device does not restrict the overcharge protection operation voltage of the battery cell, and thus the battery cell corresponding to the graph 703 may have a swelling phenomenon or the lifespan thereof may be shortened.

In FIG. 8, a graph 801 is a graph showing voltages applied to the battery module 302 or the battery pack. A graph 805 and a graph 807 are graphs showing charging voltages of the battery cell that operates within a normal operation voltage range of 4.35 V. A graph 803 is a charging voltage graph of the battery cell of which the overcharge protection operation voltage is lowered to a predetermined voltage of 4.35 V (for example, the third specified voltage) since the number of overcharge protection operations reaches a predetermined number. In the graph 803, the electronic device 101 and/or the battery device 310 according to the disclosure may extend the lifespan of the battery cell and guarantee the performance of the battery cell by reducing the overcharge protection operation voltage of the battery cell of which the number of overcharge protection operations reaches the predetermined number.

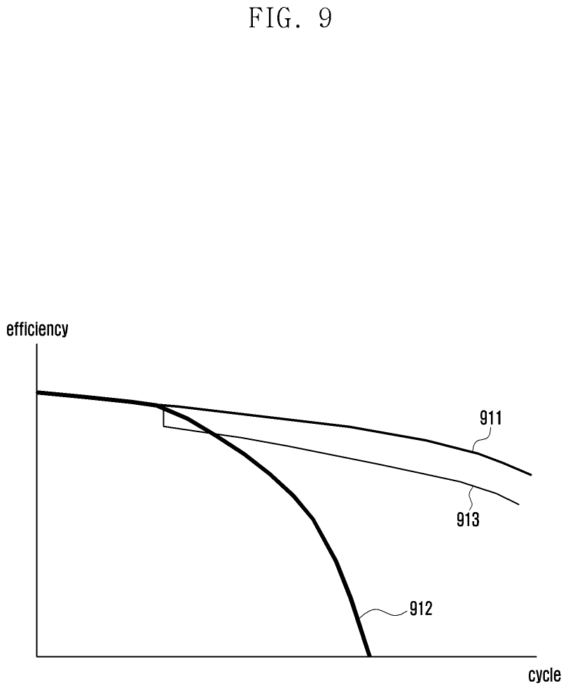

FIG. 9 is a graph showing the number (cycle) of recharging of the battery cell according to the battery control operation according to various embodiments.

A graph 911 is a graph showing the number of recharging of the normal battery cell. A graph 912 is a graph showing the number of normal recharging of a non-uniformly manufactured battery cell. A graph 913 is a graph showing the number of recharging of the battery cell when the overcharge protection operation voltage of the non-uniformly manufactured battery cell is reduced according to the battery control operation of the disclosure. With reference to the graph 912 and the graph 913, it may be identified that the number of recharging of the battery cell increases when the overcharge protection operation voltage of the non-uniformly manufactured battery cell is reduced.

The electronic device according to various embodiments set forth herein may be one of various types of electronic devices. The electronic device may include, for example, a portable communication device (e.g., a smart phone), a computer device, a portable multimedia device, a portable medical device, a camera, a wearable device, a home appliance, or the like. The electronic device according to embodiments of the disclosure is not limited to those described above.

It should be appreciated that the various embodiments and the terms used therein are not intended to limit the technological features set forth herein to particular embodiments and the disclosure includes various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one or all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), the element may be coupled/connected with/to the other element directly (e.g., wiredly), wirelessly, or via a third element.

As used in various embodiments of the disclosure, the term “module” may include a unit implemented in hardware, software, or firmware, or any combination thereof, and may be interchangeably used with other terms, for example, “logic,” “logic block,” “component,” or “circuit”. The “module” may be a single integrated component, or a minimum unit or part thereof, adapted to perform one or more functions. For example, according to an embodiment, the “module” may be implemented in the form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions each may include a code generated by a compiler or a code executable by an interpreter. The machine-readable storage medium may be provided in the form of a non-transitory storage medium. Herein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may be separately disposed in another element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a first battery cell and a second battery cell connected to the first battery cell in series;
a charging circuit configured to supply power of a first specified voltage from outside to the first battery cell and the second battery cell; and
at least one processor, comprising processing circuitry, individually and/or collectively, configured to control overcharge protection operation voltages of the first battery cell and the second battery cell to be a second specified voltage,
memory storing instructions, at least one processor, individually and/or collectively, is configured to execute the instructions and to cause the electronic device to:
identify a voltage of the first battery cell and a voltage of the second battery cell while the first battery cell and the second battery cell are charged using the power of the first specified voltage;
based on at least one voltage of the voltage of the first battery cell and the voltage of the second battery cell being greater than the second specified voltage, accumulate a number of overcharge protection operations for a battery cell having a voltage greater than the second specified voltage; and
based on the number of overcharge protection operations for the battery cell having the voltage greater than the second specified voltage reaching a specified number, configure an overcharge protection operation voltage for the battery cell having the voltage greater than the second specified voltage as a third specified voltage less than the second specified voltage.

2. The electronic device of claim 1, wherein the first specified voltage is less than the second specified voltage.

3. The electronic device of claim 1, wherein at least one processor, individually and/or collectively, is configured to cause the electronic device to, based on the number of overcharge protection operations for the battery cell having the voltage greater than the second specified voltage being successively accumulated and reaching the specified number, configure the overcharge protection operation voltage for the battery cell having the voltage greater than the second specified voltage as a third specified voltage less than the second specified voltage.

4. The electronic device of claim 1, wherein at least one processor, individually and/or collectively, is configured to cause the electronic device to, based on the number of overcharge protection operations for the battery cell having the voltage greater than the second specified voltage not being successively accumulated and not reaching the specified number, maintain the overcharge protection operation voltage as the second specified voltage.

5. The electronic device of claim 1, wherein at least one processor, individually and/or collectively, is configured to cause the electronic device to, based on the first battery cell and the second battery cell being in a protection operation voltage range, perform control to supply power to the first battery cell and the second battery cell.

6. The electronic device of claim 5, wherein at least one processor, individually and/or collectively, is configured to cause the electronic device to, based on the first battery cell and the second battery cell exceeding the protection operation voltage range, perform control to block power supply to the first battery cell and the second battery cell, and
wherein the overcharge protection operation voltage range has the overcharge protection operation voltage as an upper limit and an overdischarge protection operation voltage as a lower limit.

7. The electronic device of claim 1, wherein at least one processor, individually and/or collectively, is configured to cause the electronic device to, based on the number of overcharge protection operations for the battery cell having the voltage greater than the second specified voltage reaching the specified number, configure the overcharge protection operation voltage for the battery cell having the voltage greater than the second specified voltage to be reduced by a specified voltage.

8. The electronic device of claim 1, wherein the first specified voltage is an upper limit of a normal operation voltage range of the first battery cell and the second battery cell.

9. A method of controlling a battery of an electronic device comprising a first battery cell and a second battery connected to the first battery cell in series, the method comprising:
identifying a voltage of the first battery cell and a voltage of the second battery cell while the first battery cell and the second battery cell are charged using the power of the first specified voltage;
based on at least one voltage of the voltage of the first battery cell and the voltage of the second battery cell being greater than the second specified voltage, accumulating a number of overcharge protection operations for a battery cell having a voltage greater than the second specified voltage; and
based on the number of overcharge protection operations for the battery cell having the voltage greater than the second specified voltage reaching a specified number, configuring an overcharge protection operation voltage for the battery cell having the voltage greater than the second specified voltage as a third specified voltage less than the second specified voltage.

10. The method of claim 9, wherein the first specified voltage is less than the second specified voltage.

11. The method of claim 9, further comprising, based on the number of overcharge protection operations for the battery cell having the voltage greater than the second specified voltage being successively accumulated and reaching the specified number, configuring the overcharge protection operation voltage for the battery cell having the voltage greater than the second specified voltage as a third specified voltage less than the second specified voltage.

12. The method of claim 9, wherein, based on the number of overcharge protection operations for the battery cell having the voltage greater than the second specified voltage not being successively accumulated and not reaching the specified number, the overcharge protection operation voltage is maintained as the second specified voltage.

13. The method of claim 10, further comprising, based on the first battery cell and the second battery cell being in a protection operation voltage range, performing control to supply power to the first battery cell and the second battery cell.

14. The method of claim 13, further comprising, based on the first battery cell and the second battery cell exceeding the protection operation voltage range, performing control to block power supply to the first battery cell and the second battery cell,
wherein the overcharge protection operation voltage range has the overcharge protection operation voltage as an upper limit and an overdischarge protection operation voltage as a lower limit.

15. The method of claim 10, further comprising, based on the number of overcharge protection operations for the battery cell having the voltage greater than the second specified voltage reaching the specified number, configuring the overcharge protection operation voltage for the battery cell having the voltage greater than the second specified voltage to be reduced by a specified voltage.
